(19) United States
(12) Patent Application Publication
(10) Pub. No.: US 2020/0125169 A1
(43) Pub. Date: Apr. 23, 2020

(54) Systems and Methods for Correcting Lens Distortion in Head Mounted Displays

(71) Applicant: EyeTech Digital Systems, Inc., Mesa, AZ (US)

(72) Inventors: Robert C. Chappell, Mesa, AZ (US); Michael Scott Holford, Gilbert, AZ (US); James Wesley Rogers, JR., Mesa, AZ (US)

(21) Appl. No.: 16/656,035

(22) Filed: Oct. 17, 2019

Related U.S. Application Data
(60) Provisional application No. 62/747,322, filed on Oct. 18, 2018.

(51) Int. Cl. G06F 3/01; H04N 5/225; G06T 7/70; G02B 27/00; G02B 27/14

(52) U.S. Cl. CPC G06F 3/013; H04N 5/2256; H04N 5/2254; G06T 2207/30201; H04N 5/2258; G02B 27/0025; G02B 27/141; G06T 7/70

(57) ABSTRACT

An eye tracking system is provided for use in a head-mounted display of the type that includes a display screen viewable by a user through a first lens. The eye-tracking system includes at least one infrared LED configured to illuminate the user's eye and a first mirror positioned between the first lens and the display screen, wherein the first mirror has a convex face configured to substantially reflect infrared light received from the user's illuminated eye. The system includes an image sensor configured to receive infrared light reflected by the first mirror to thereby produce an image of the user's illuminated eye. An eye-tracking module communicatively coupled to the image sensor is configured to determine a gaze point on the display screen based on the image of the user's illuminated eye.

### CROSS-REFERENCE TO RELATED APPLICATIONS

This application claims priority to U.S. Provisional Patent Application No. 62/747,322, filed Oct. 18, 2018, the entire contents of which are hereby incorporated by reference.

### TECHNICAL FIELD

The present invention relates, generally, to head-mounted displays and, more particularly, to lens distortion correction for eye tracking systems used in connection with such displays.

### BACKGROUND

Recent years have seen dramatic advances in the performance of virtual reality headsets and other such head-mounted displays (HMDs). Despite these improvements, many users find the long-term use of HMDs uncomfortable due to their overall size and weight. More particularly, as the overall lateral dimension or “depth” of an HIVID increases, the rotational force (or moment) applied to the user's head also increases, which can result in significant neck strain. For these and other reasons, there have been significant efforts by HIVID manufactures to reduce the depth of the headset—i.e., to bring the headset closer to the face.

This reduction in HIVID size has a number of undesirable consequences, however. For example, in smaller HMDs that employ eye-tracking systems (i.e., systems for determining a gaze point on the internal display screen of the HIVID), the resulting distortion, reduction in depth-of-field, and compact arrangement of optical components makes it difficult to provide accurate eye-tracking results, particularly for users whose inter-pupillary distance (IPD) is significantly larger or smaller than the general population. This problem is exacerbated by the use of relatively large and thick VR lenses in such systems.

Systems and methods are therefore needed that overcome these and other limitations of the prior art.

### SUMMARY OF THE INVENTION

Various embodiments of the present invention relate to systems and methods for, inter alia: i) providing eye-tracking in a compact head-mounted display through the use of an IR-reflecting convex mirror in conjunction with an off-axis image sensor; ii) correcting for lens distortion in a head-mounted display through the use of an IR-reflecting convex mirror; iii) providing eye-tracking support for a wider range of inter-pupillary distances (IPDs); and iv) performing slippage compensation to reduce errors in eye-tracking systems. Various other embodiments, aspects, and features are described in greater detail below.

### BRIEF DESCRIPTION OF THE DRAWING FIGURES

The present invention will hereinafter be described in conjunction with the appended drawing figures, wherein like numerals denote like elements, and:

FIG. 1 illustrates the use of a head-mounted display in accordance with various embodiments;

FIG. 2 is a schematic diagram of one half of an optical system for eye tracking in accordance with various embodiments;

FIG. 3 illustrates the imaging of a user's corneal reflections (CRs) and pupil center (PC) in accordance with various embodiments; and

FIGS. 4-6 illustrate partial cut-away views (top, front, and isometric views, respectively) of a head-mounted display in accordance with one embodiment.

### DETAILED DESCRIPTION OF PREFERRED EXEMPLARY EMBODIMENTS

The present subject matter relates to improved, compact optical systems for performing eye tracking in head-mounted displays. The disclosed systems and methods minimize or eliminate lens distortion—even in systems with large, thick VR lenses—and are compatible with a wide range of inter-pupillary distances. In that regard, the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to lenses, mirrors, head-mounted displays, eye-tracking algorithms, and digital image processing may not be described in detail herein.

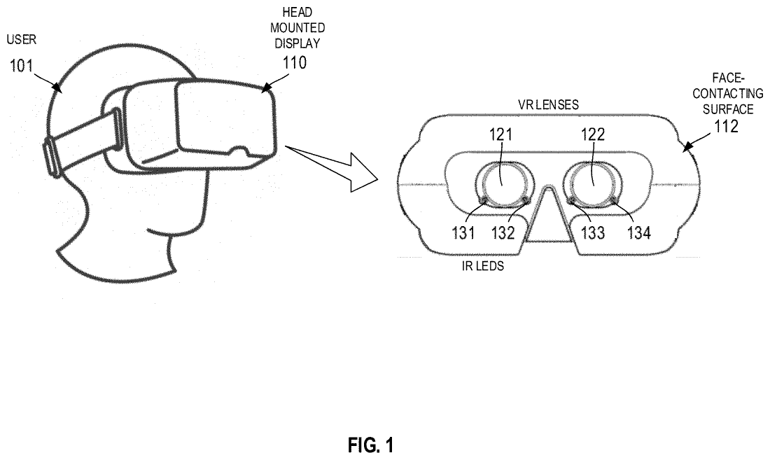

Referring first to FIG. 1, the present invention generally relates to a head-mounted display system 110 configured to be worn by a user 101. As used herein the term “head-mounted display” (or “HMD”) refers to any display device worn by a user (e.g., a headset, helmet, or wearable eyewear) such that the user 101 may view an image produced by one or more displays and associated optical components provided within the HIVID 110. As shown in FIG. 1, for example, HIVID 110 may include a face-contacting surface 112 (e.g., a deformable foam or rubber material) that frames a set of virtual reality (VR) lenses 121 and 122—each having an associated pair of infrared (IR) light emitting diodes (LEDs) (131 and 132; 133 and 134) used in connection with tracking the eye movements of user 101, as described in further detail below.

HMD 110 may be used in the context of virtual reality, augmented reality, or mixed reality applications. Accordingly, the term “virtual reality headset,” is used herein without loss of generality. Furthermore, while the illustrated embodiments are presented in the context of binocular vision, the various optical systems and methods described herein may also be used in the connection with monocular eye tracking.

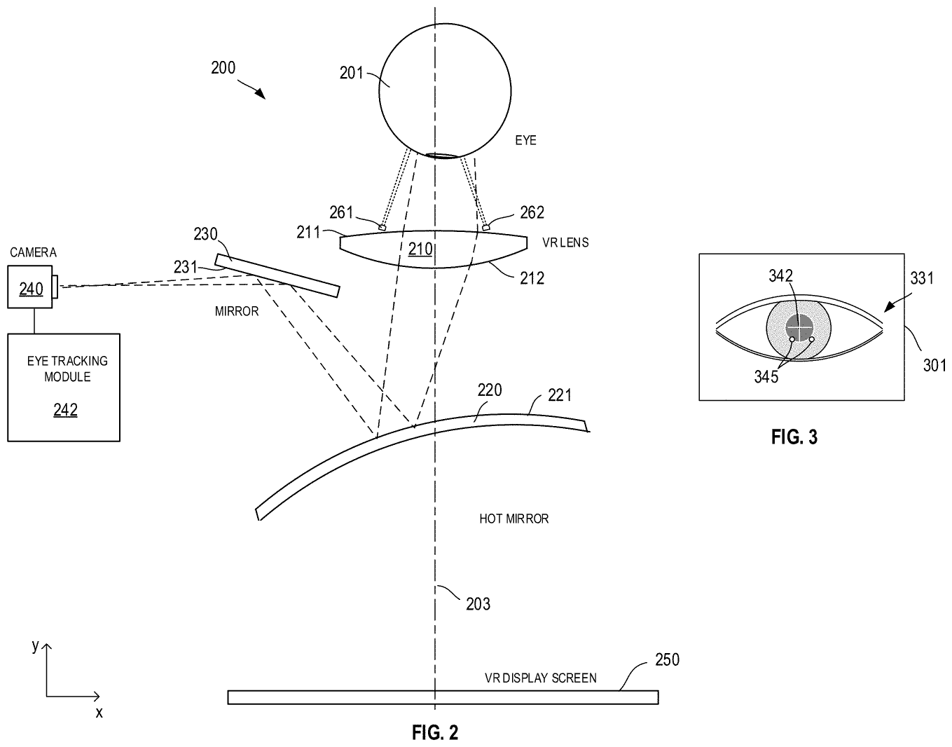

Referring now to the schematic diagram of FIG. 2, an HIVID eye-tracking optical system (or simply “optical system”) 200 generally includes, for each eye, a VR lens (or simply “lens”) 210 having a front surface 211 facing an eye 201 of the user, and a back surface 212 facing a display screen 250 (e.g., an LED, OLED screen, or the like) configured to display the optical image being observed by the user via eye 201. The central axis 203 of VR lens 210 is generally perpendicular to and centrally aligned with display screen 250. In this regard, the term “VR lens” (or “first lens” as used herein) refers to the lens (e.g., convex lens) or group of lenses that are adjacent to the user's eyes during normal operation of HIVID 110.

One or more IR LEDs 261 and 262 (e.g., 850, 880, or 940 nm LEDs) are provided adjacent to the front surface 211 of VR lens 210 for performing eye tracking as described in further detail below. Thus, VR lens 210 may correspond to VR lens 122 of FIG. 1, and IR LEDs 261 and 262 may correspond to IR LEDs 133 and 134.

With continued reference to FIG. 2, a hot mirror 220 (also referred to as the “first mirror”) having a convex surface 221 is positioned between VR lens 210 and display screen 250. As used herein, the term “hot mirror” refers to a dielectric mirror that reflects at least a portion of the incident infrared light while allowing the transmission of light in the visible spectrum. In one embodiment, hot mirror 220 reflects light having a wavelength of 750 nm or higher. Hot mirror 220 may be selected and/or coated such that it passes greater than 90% of visible light (400 nm-700 nm) and reflects greater than 90% of infrared light (e.g., greater than 700 nm). Thus, hot mirror 220 does not significantly impede the viewing, by eye 201, of visible light produced by display screen 250.

In the illustrated embodiment, hot mirror 220 is offset laterally (e.g., along the x-axis) a predetermined distance from central axis 203, and convex surface 221 is generally oriented at a predetermined angle such that hot mirror 220 reflects infrared light (e.g., light produced by IR LEDs 261 and 262) off-axis onto a second mirror 230.

Mirror 230 (which is also configured to reflect at least a portion of incident infrared light) is oriented such that surface 231 reflects the incident infrared light onto an image sensor or camera 240 (which may have an associated lens) that is configured to thereby acquire an infrared image of eye 201 to be used (e.g., by eye tracking module 242) to achieve the eye-tracking functionality described herein.

In this regard, as used herein the phrase “eye tracking system” refers to the components of optical system 200 that are used primarily to provide eye tracking functionality—i.e., IR LEDs 261 and 262, hot mirror 220, mirror 230, camera 240, eye-tracking module 242, and the various software code executed by eye-tracking module 242, which may be implemented using a variety of suitable software platforms and languages.

In that regard, the dotted lines in FIG. 2 generally illustrate the optical path of infrared light produced by IR LEDs 261 and 262—i.e., the IR reflections pass through VR lens 210, are reflected by the concave surface 221 of hot mirror 220, and are further reflected by surface 231 of mirror 230 onto camera 240. In the illustrated embodiment, the central axis of camera 240 is substantially perpendicular to axis 203 of VR lens 210. In an alternate embodiment, a properly configured, miniature camera is used in place of mirror 230 and is oriented such that it collects incident infrared light reflected by hot mirror 220.

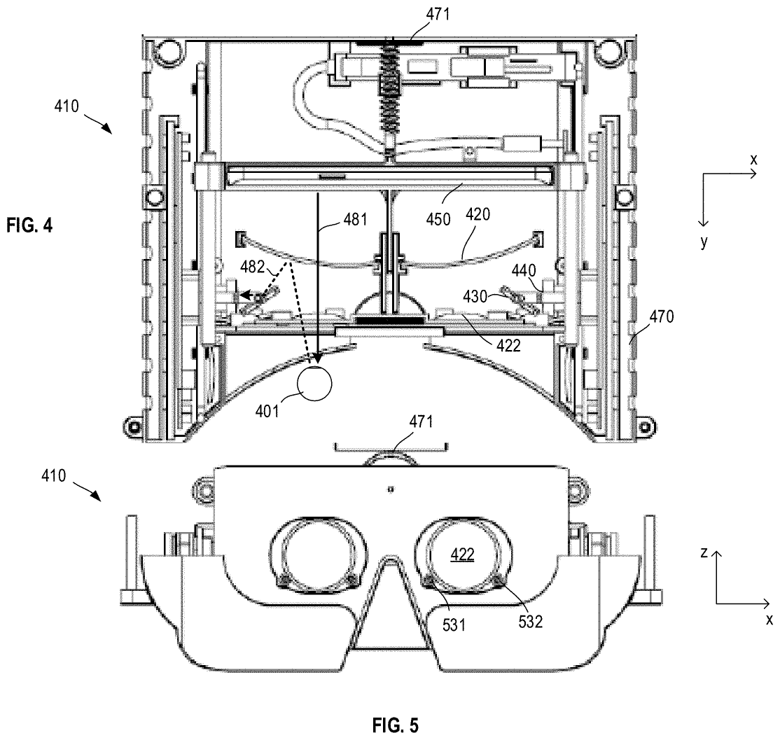

The resulting image 301, as shown in FIG. 3, may be provided to an image processing module within HMD 110 (or external to HMD 110) to determine a pair of corneal reflections (CRs) 345 and a pupil center (PC) 342 of the observed eye 331. The relative positions of the CRs and PC as observed by camera 240 may be used by eye tracking module 242 to determine, using a variety of eye-tracking algorithms, the point of gaze of user 101 on display screen 250. In that regard, the optical systems described herein are agnostic to any particular eye-tracking algorithm and may thus be used in a wide variety of eye tracking contexts.

The sizes, shapes, relative positions, and materials of the components used to implement the optical system 200 illustrated in FIG. 2 may be selected based on a variety of factors, such as the desired size, shape, and weight of HIVID 110. By way of one non-limiting example, system 200 may be configured such that: The distance (along the y-axis) between eye 201 and VR lens 210 is approximately 1-4 cm (e.g., 2 cm); the distance between the centers of VR lens 210 and hot mirror 220 is approximately 1-4 cm (e.g., 2 cm); the distance between the centers of hot mirror 220 and mirror 230 is approximately 1-4 cm (e.g., 2 cm); the distance between the center of mirror 230 to the image plane of camera 240 is approximately 1-4 cm (e.g., 2 cm); mirror 230 has a lateral length (as viewed in FIG. 2) of approximately 20 mm, and camera 240 includes a lens having a diameter of approximately 4 mm.

The use of a convex hot mirror 220 results in a number of benefits. For example, the image eye 201 as reflected from convex surface 221 is smaller than what would be reflecting from a planar mirror. Because the eye takes up less area in the image, this allows the eye 201 to be observed by camera 240 at a wider range of inter-pupillary distances. In addition, by using a convex hot mirror 220, at least a portion of the distortion and magnification caused by the relatively large, thick VR lens 210 can be reversed or eliminated, providing a more accurate image of eye 201.

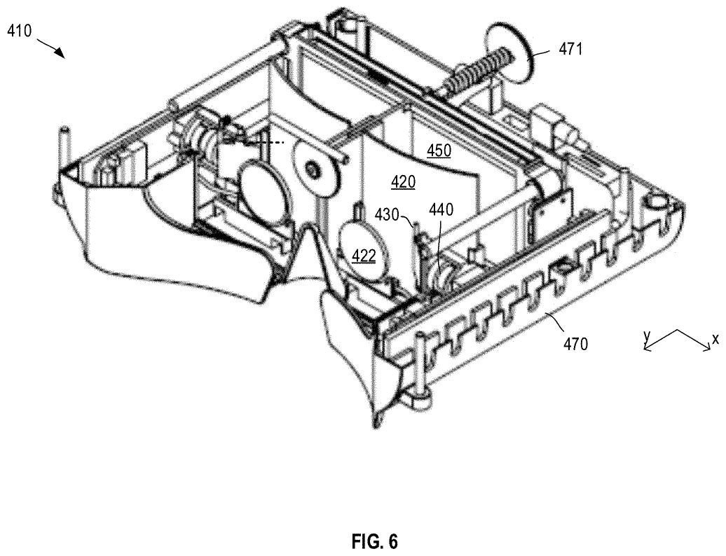

FIGS. 4-6 illustrate partial cut-away views (i.e., top, front, and isometric views, respectively) of an HMD 410 in accordance with one embodiment. In the interest of clarity, only one half of the components of HIVID 410 is labeled with reference numerals. It will be appreciated that HIVID 410 is characterized by reflectional symmetry such that it provides a substantially identical optical path to both eyes.

More particularly, as shown in FIG. 4-6, HIVID 410 includes a VR lens 422, a hot mirror 420, a mirror 430, two IR LEDs 531 and 532, a display screen 450, and a camera 440 enclosed within a housing 470. The optical path provided by these components is substantially the same as that illustrated in FIG. 2, and is illustrated in FIG. 4 via eye 401, visible light path 481, and IR light path 482. HIVID 410 also includes, in this embodiment, a dial or other mechanical actuator 471 configured to allow the user to change the focal length and/or position of various optical components of HIVID 410. Additional dials or mechanical actuators may also be incorporated into HIVID 410 to adjust for the user's IPD and/or other geometrical factors.

HIVID 410 will generally include various electronic components and software configured to accomplish the virtual reality imaging functions described herein (including, for example, eye tracking module 242 of FIG. 2). Thus, for example, the processing module will generally include a user interface module, a range of sensors (e.g., position, orientation, and acceleration sensors), one or more central processing units (CPUs) or other processor, one or more memory components, one or more storage components, a power supply, and network interfaces and other I/O interfaces as might be required in the context of virtual reality systems. The processing module is configured to execute various software components provided within or otherwise transferred to system 410 during operation.

In some embodiments, eye tracking is accomplished by an eye tracking module that is remote from the actual HMD 110. That is, certain imaging data may be transferred over a network to a remote server which then performs at least a portion of the computationally complex operations necessary to determine the CR, PC, or other gaze point data, which is then transmitted back over the network to HIVID 110. In some embodiments, however, eye tracking is computed by an eye tracking module 242 residing with the housing of HIVID 110 or tethered to HIVID 110 via a high-speed data connection.

In accordance with various embodiments, HIVID 110 incorporates various forms of slippage and/or position compensation. More particularly, the image produced by the image sensor 240 is processed to determine the offsets of the positions of the user's pupils and glints—the corneal reflections produced by the IR illuminators. For each eye, these offsets serve as the input to one or more interpolation functions that determine gaze point within a field of interest, typically a display screen; although in some cases it might be a scene camera FOV. The interpolation functions are determined by the data generated when a user performs a calibration. During a calibration, a user is asked to focus his eyes on a number of targets arranged on his display screen while data such as pupil and glint locations, corneal distance, and pupil diameter are collected.

It has been found by the present inventors that the resulting interpolation functions are most accurate, i.e. the gaze point that they output is closest to what the user is actually looking at on the target display screen, when the user's eyes remain at the position where the calibration was performed. However, a HMD 110 may shift on a user's head, i.e., to the left or right and/or up or down. This slippage changes the position of the eyes with respect to the image sensor 240 and IR LEDs 261, 262. For a standalone tracker, the user is free to move his head or body, thus changing the position of his eyes with respect to the image sensor and IR LEDs. The farther the user's eyes stray from the calibration position, the less accurate the gaze point determination becomes.

Slippage or position compensation is intended to minimize the effect of a change of eye position on the accuracy of gaze point determination. In accordance with the present invention, the position of the glints and CRs in the sensor image, along with the distance information calculated by the geometric models, may be used to normalize the pupil/glint offset data to make it less dependent on eye position.

It will be appreciated that the slippage compensation techniques described above are not limited to head-mounted displays, and may be used, for example, in conjunction with remote trackers—i.e., eye tracking systems that are fixed to the bottom portion of a desktop or laptop computer display.

In summary, what has been described herein are various systems and methods for providing eye-tracking in compact head-mounted displays. In accordance with one embodiment, an eye-tracking system includes at least one infrared LED configured to illuminate the user's eye and a first mirror positioned between the first lens and the display screen, wherein the first mirror has a convex face configured to substantially reflect infrared light received from the user's illuminated eye. The system includes an image sensor configured to receive infrared light reflected by the first mirror to thereby produce an image of the user's illuminated eye. An eye-tracking module communicatively coupled to the image sensor is configured to determine a gaze point on the display screen based on the image of the user's illuminated eye.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refer to any hardware, software, firmware, electronic control component, processing logic, and/or processor device, individually or in any combination, including without limitation: application specific integrated circuits (ASICs), field-programmable gate-arrays (FPGAs), dedicated neural network devices (e.g., Google Tensor Processing Units), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. An eye tracking system for use in a head-mounted display that includes a display screen viewable by a user through a first lens, the eye tracking system comprising:
at least one infrared LED configured to illuminate the user's eye;
a first mirror positioned between the first lens and the display screen, wherein the first mirror has a convex face configured to substantially reflect infrared light received from the user's illuminated eye;
an image sensor configured to receive infrared light reflected by the first mirror to thereby produce an image of the user's illuminated eye; and
an eye-tracking module communicatively coupled to the image sensor, the eye-tracking module configured to determine a gaze point on the display screen based on the image of the user's illuminated eye.

2. The eye tracking system of claim 1, further including a second mirror optically interposed between the image sensor and the first mirror, wherein the camera axis is substantially perpendicular to a central axis of the first lens.

3. The eye tracking system of claim 1, wherein the first mirror is configured to transmit at least 90% of light having a wavelength in the range of 400-700 nm and to reflect at least 90% of light having a wavelength greater than 700 nm.

4. The eye tracking system of claim 1, wherein the at least one infrared LED is selected from the group consisting of 850 nm IR LEDs, 880 nm IR LEDSs, and 940 nm LEDs.

5. The eye tracking system of claim 1, wherein the eye-tracking module is further configured to perform a slippage compensation procedure to determine the gaze point.

6. A head-mounted display comprising:
a housing configured to be releasably attached to a user's head;
first and second VR lenses coupled to an exterior surface of the housing;
at least one display screen viewable by the user through the first and second VR lenses;
a set of infrared LEDs configured to illuminate the user's eyes;
a pair of first mirrors positioned between the VR lenses and the at least one display screen, wherein the first mirrors each have a convex face configured to substantially reflect infrared light received from the user's illuminated eyes;
a pair of image sensors configured to receive infrared light reflected by the corresponding first mirror to thereby produce images of the user's illuminated eyes; and
an eye-tracking module communicatively coupled to the image sensors, the eye-tracking module configured to determine a gaze point on the display screen based on the images of the user's illuminated eyes.

7. The head-mounted display of claim 6, further including a pair of second mirrors optically interposed between the corresponding image sensors and first mirrors, wherein the camera axes are substantially perpendicular to a central axis of the VR lenses.

8. The head-mounted display of claim 6, wherein each of the first mirrors is configured to transmit at least 90% of light having a wavelength in the range of 400-700 nm and to reflect at least 90% of light having a wavelength greater than 700 nm.

9. The head-mounted display of claim 6, wherein the at least one infrared LED is selected from the group consisting of 850 nm IR LEDs, 880 nm IR LEDSs, and 940 nm LEDs.

10. The head-mounted display of claim 6, wherein the eye-tracking module is further configured to perform a slippage compensation procedure to determine the gaze point.

11. A method of tracking a user's eyes in a head-mounted display that includes a housing configured to be releasably attached to a user's head, first and second VR lenses coupled to an exterior surface of the housing, and at least one display screen viewable by the user through the first and second VR lenses; the method comprising:
fixing a set of infrared LEDs to the housing such that they illuminate the user's eyes;
providing a pair of first mirrors positioned between the VR lenses and the at least one display screen, wherein the first mirrors each have a convex face configured to substantially reflect infrared light received from the user's illuminated eyes;
receiving, at a pair of image sensors, infrared light reflected by the corresponding first mirror to thereby produce images of the user's illuminated eyes; and
determining, with an eye-tracking module communicatively coupled to the image sensors, a gaze point on the display screen based on the images of the user's illuminated eyes.

12. The method of claim 11, further including a second mirror optically interposed between the image sensor and the first mirror, wherein the camera axis is substantially perpendicular to a central axis of the first lens.

13. The method of claim 11, wherein the first mirror is configured to transmit at least 90% of light having a wavelength in the range of 400-700 nm and to reflect at least 90% of light having a wavelength greater than 700 nm.

14. The method of claim 11, wherein the at least one infrared LED is selected from the group consisting of 850 nm IR LEDs, 880 nm IR LEDSs, and 940 nm LEDs.

15. The method of claim 11, further including performing a slippage compensation procedure to determine the gaze point.
